(19) United States
(12) Patent Application Publication
(10) Pub. No.: US 2022/0217941 A1
(43) Pub. Date: Jul. 14, 2022

(54) A smart feeding device for cats

(71) Applicant: SHANGHAI LIANCHONG INTELLIGENT TECHNOLOGY CO., LTD., Shanghai (CN)

(72) Inventors: Fei Huang, Shanghai (CN); Guoqing Li, Shanghai (CN)

(21) Appl. No.: 17/609,834

(22) PCT Filed: Mar. 11, 2021
(86) PCT No.: PCT/CN2021/080221

§ 371 Date: Nov. 9, 2021

(30) Foreign Application Priority Data
Apr. 21, 2020 (CN) 202010315099.X

(51) Int. Cl. A01K 5/02

(52) U.S. Cl. CPC A01K 5/0283

(57) ABSTRACT

A smart feeding device for cats, comprises a feeder body and a food discharge mechanism provided on the feeder body; the food discharge mechanism comprises a food bowl and a weighing tray; the food bowl is fixed to the weighing tray; a tray fixing member is fixed at the bottom of the weighing tray; and a weighing sensor is arranged in the tray fixing member. The device also comprises a device for recognizing multiple cats and a food scattering device. The food scattering device is arranged in a food storage bin of the feeder body and comprises silica gel blades, food discharge blades and a food discharge impeller box which are sequentially arranged from top to bottom. Cat food in the food bowl is weighed by means of the weighing sensor, and the weight of the cat food eaten each time by the cats may be known.

### TECHNICAL FIELD

The present invention relates to a technical field of pet feeding, specifically an intelligent cat feeder.

### BACKGROUND TECHNOLOGY

When feeding a plurality of cats with the cat feeders currently available, it is difficult to know which cat(s) has/have been fed, and identify an eating amount of each cat, therefore, it is not possible to monitor dining conditions and health conditions of each cat, and in the meanwhile, the cat feeders currently available are subject to food jamming.

### SUMMARY OF THE INVENTION

### 1. Technical Problem(s) to be Addressed

A purpose of the present invention is to address the technical problems that it is not possible to monitor dining conditions and health conditions of each cat with the cat feeders currently available.

### 2. Technical Solution

To achieve the foregoing purpose, a technical solution provided in the present invention is:

An intelligent cat feeder according to the present invention, comprises a feeder body and a food holding mechanism provided in the feeder body, and the food holding mechanism comprises a food bowl and a weighing pallet, wherein the food bowl is provided on the weighing pallet, a pallet fixing piece is provided at a bottom portion of the weighing pallet, a load cell is provided in the pallet fixing piece; the intelligent cat feeder further comprises a cat identification device and a food unjamming device, wherein the food unjamming device is provided in a food cavity in the feeder body, and the food unjamming device comprises silica gel blades, food releasing blades and a food releasing impeller casing provided in sequence from top down, wherein the silica gel blades, the food releasing blades are coaxially provided, and the food releasing blades are provided in a food guiding groove in the food releasing impeller casing, and a food jamming prevention stopper one and a food jamming prevention stopper two are provided at an outlet of the food guiding groove.

Preferably, the cat identification device comprises one or more electronic tags and a pedestal provided at a lower end of the feeder body, the food holding mechanism is provided in the pedestal, a signal receiver and one or more storage batteries are provided in the pedestal, and the signal receiver is connected with the one or more storage batteries, a controller is provided in the pedestal, and the controller is connected electrically with both the signal receiver and the one or more storage batteries; the one or more electronic tags cooperate with the signal receiver and the controller is connected electrically with the load cell.

Preferably, stopping mechanisms are provided at both sides of the food holding mechanism, and the stopping mechanisms at the both sides form an opening, wherein the stopping mechanisms are arc-shaped stopping plates, installation bulges extending downwardly are provided at bottom portions of the stopping mechanisms, a fixing layer is provided on both sides of the feeder body, and a vertical slot is provided in the fixing layer, and the vertical slot engages with the installation bulges to connect the stopping mechanisms with the fixing layer.

Preferably, a ring-shaped groove and a circular groove are provided in the pedestal from bottom up, wherein the weighing pallet is provided in the ring-shaped groove, both the pallet fixing piece and the load cell are provided in the circular groove, and the pallet fixing piece is fixedly connected with an installation piece in the circular groove.

Preferably, a battery compartment is provided in the pedestal, the one or more storage batteries are provided in the battery compartment, a fixing block is provided at a side of the battery compartment, a fixing assembly is connected to the fixing block via screws, a fixing slot is provided in the fixing assembly, and the controller is provided in the fixing slot.

Preferably, a fixing cap adapted to an upper end of a shaft of the silica gel blades is provided thereon, and the food jamming prevention stopper one and the food jamming prevention stopper two are perpendicular to each other in a horizontal direction.

Preferably, a food outlet is provided in the feeder body close to the opening, and a food outlet direction at the food outlet is against the food bowl.

Preferably, a width of the opening is 10˜20 cm, and a height of the stopper mechanisms are 20˜30 cm.

Preferably, the installation bulges comprises an installation bulge one, an installation bulge two, an installation bulge three and an installation bulge four, wherein both sides of at least one of the installation bulge one, the installation bulge two, the installation bulge three and the installation bulge four are provided with fixing mechanisms.

Preferably, the battery compartment comprises a battery cover, and the battery cover is provided with battery cover bulges engaging with the battery compartment.

### 3. Beneficial Effects

Compared with the prior art, the technical solution provided in the present invention has following beneficial effects:

The intelligent cat feeder according to the present invention, comprises a feeder body and a food holding mechanism, wherein the food holding mechanism comprises a food bowl and a weighing pallet, wherein the food bowl is fixed on the weighing pallet, a pallet fixing piece is provided at a bottom portion of the weighing pallet, a load cell is provided in the pallet fixing piece; the intelligent cat feeder further comprises a cat identification device and a food unjamming device, wherein the food unjamming device is provided at a food cavity in the feeder body, and the food unjamming device includes silica gel blades, food releasing blades, and a food releasing impeller casing provided in sequence from top down, wherein the silica gel blades and the food releasing blades are coaxially provided, the food releasing blades are provided in a food guiding groove in the food releasing impeller casing, and a jamming prevention stopper one and a jamming prevention stopper two are provided at an outlet of the food guiding groove. By weighing the cat food in the food bowl with the load cell, it is possible to know weight of the cat food each time eaten by the cat, in the meantime, it is possible to identify the dining cat(s) and dining time(s) with the cat identification device, and by matching the dining cat(s) and dining time(s) and the weight of eaten cat food, it is possible to record dining conditions of each cat and know health condition of the cat(s). By guiding the cat food with the silica gel blades and the food releasing blades, movement of the food releasing blades will drive the silica gel blades to rotate, and when the food releasing blades are stuck, the silica gel blades as being flexible will provide a flexible action force to the stuck food so as to unjam the food; a jamming prevention stopper one and a jamming prevention stopper two are provided at an outlet of the food guiding groove, a fixing cap is provided on an upper end of a shaft of the silica gel blades, the jamming prevention stopper one and the jamming prevention stopper two are perpendicular to each other in a horizontal direction, any one of the jamming prevention stopper one and the jamming prevention stopper two faces the food outlet, so that the cat food moves towards the food outlet, and food jamming can be avoided.

### BRIEF DESCRIPTION OF DRAWINGS

FIG. 1 is a front view of the intelligent cat feeder in the present invention;

FIG. 2 is a structural diagram showing the intelligent cat feeder in the present invention;

FIG. 3 is a structural diagram showing the stopping mechanisms in the present invention;

FIG. 4 is a structural diagram showing the pedestal in the present invention;

FIG. 5 is a structural diagram showing the food holding mechanism in the present invention;

FIG. 6 is a partial view showing the pedestal in the present invention; and

FIG. 7 is a structural diagram showing the food unjamming device in the present invention.

Markups shown in the drawings are:

100. Feeder body; 110. Food outlet; 120. Food holding mechanism; 121. Food bowl; 122. Weighing pallet; 123. Pallet fixing piece; 124. Sensor installation slot; 125. Load cell; 126. Ring-shaped groove; 127. Circular groove; 128. Installation piece; 130. Pedestal; 131. Controller; 132. Fixing assembly; 133. Fixing groove; 134. Battery compartment; 135. Fixing block; 136. Signal receiver; 137. Storage battery; 138. Battery cover; 139. Battery cover bulge; 140. Cushioning layer; 150. Fixing layer;
200. stopper mechanism; 210. Transparent stopper; 211. Sticker; 221. Installation bulge one; 222. Installation bulge two; 223. Fixing mechanism; 224. Installation bulge three; 225. Installation bulge four; 230. Opening; 310. fixing cap; 320. Silica gel blade; 330. Food releasing blade; 340. Food releasing impeller casing; 350. Food guiding groove; 360. Jamming prevention stopper one; and 370. Jamming prevention stopper two.

### EMBODIMENTS

In order to facilitate understanding of the present invention, hereinafter a more comprehensive description of the present invention with reference to the relevant drawings will be given. The drawings show several embodiments of the present invention. However, the present invention can be implemented in many different forms and is not limited to this description. On the contrary, the purpose of providing these embodiments is to make the disclosure of the present invention more thorough and comprehensive.

It should be noted that when a component is referred to as being “fixed to” another component, it can be directly on the other component or there can be an intermediate component; when one component is considered to be “connected” to another component, it can be directly connected to the other component or there may be an intermediate component at the same time; the terms “vertical”, “horizontal”, “left”, “right” and similar expressions used herein are for illustrative purposes only.

Unless otherwise defined, all technical and scientific terms used herein have the same meanings as commonly understood by those skilled in the technical field of the present invention; the terms used in the specification of the present invention herein are only for describing specific embodiments instead of limiting the present invention; the term “and/or” as used herein includes any and all combinations of one or more related listed items.

### Embodiment 1

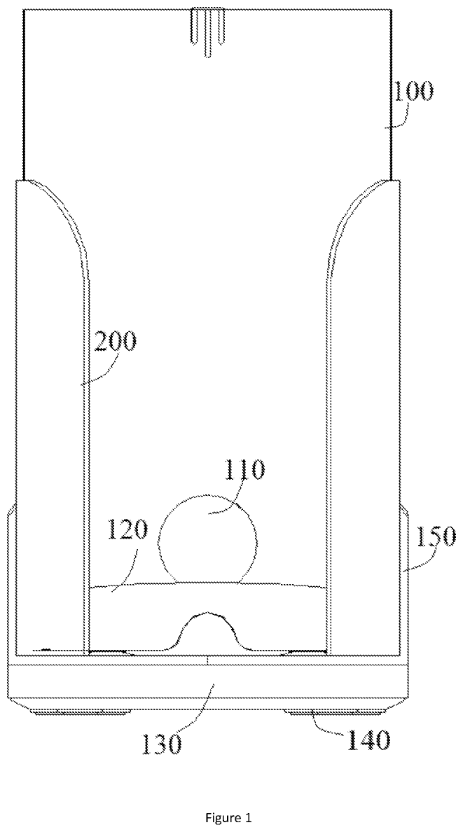

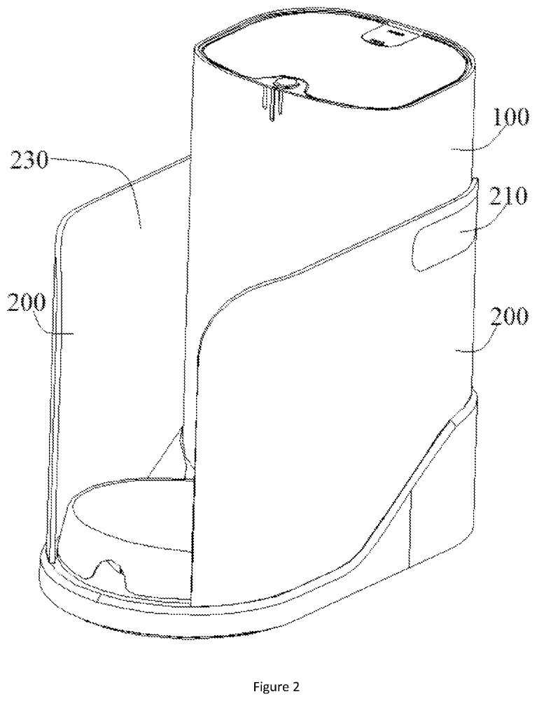

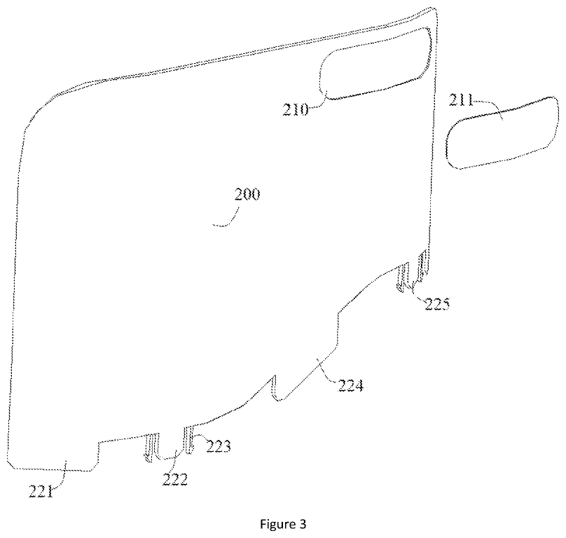

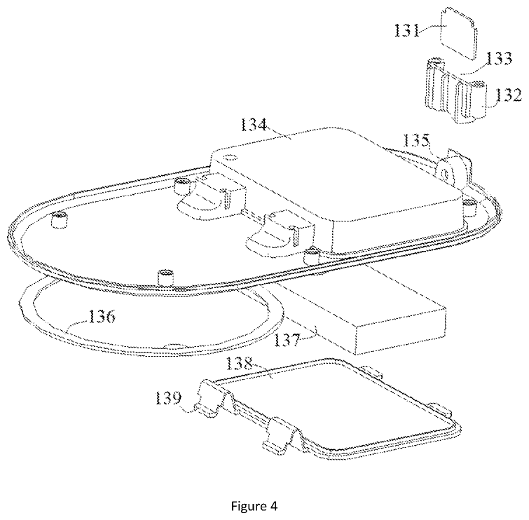

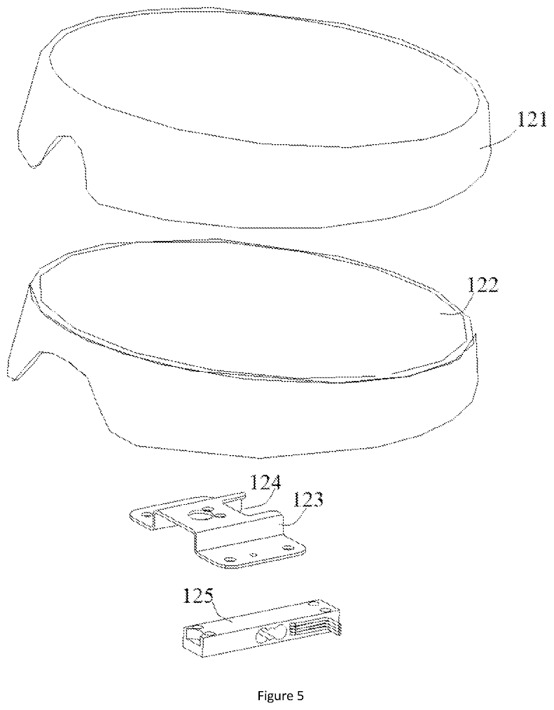

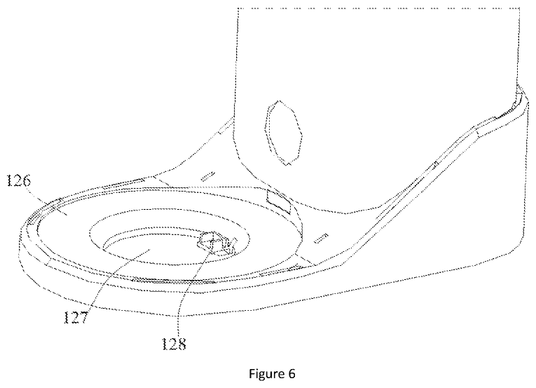

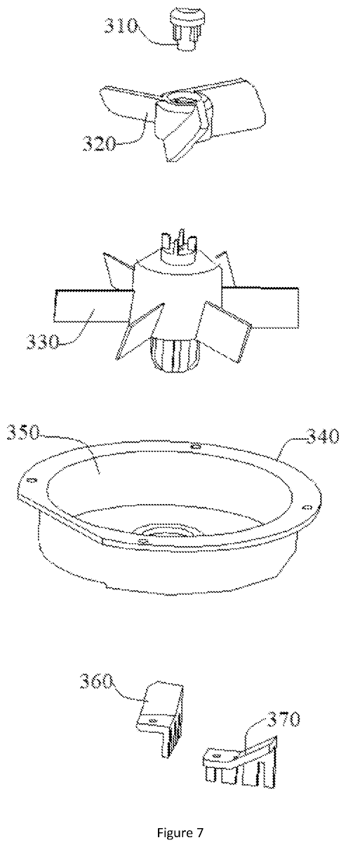

With reference to FIG. 1 to FIG. 7, an intelligent cat feeder provided in the present invention, comprises a feeder body 100, and a food holding mechanism 120 provided in the feeder body 100, wherein the food holding mechanism 120 comprises a food bowl 121 and a weighing pallet 122, a pallet fixing piece 123 is fixed at a bottom portion of the weighing pallet 122, a load cell 125 is provided in the pallet fixing piece 123; the intelligent cat feeder further comprises a cat identification device and a food unjamming device, wherein the food unjamming device is provided in a food cavity in the feeder body 100, wherein the food unjamming device comprises silica gel blades 320, food releasing blades 330 and food releasing impeller casing 340 provided in sequence from top down, the silica gel blades 320 and the food releasing blades 330 are coaxially provided, the food releasing blades 330 are provided in a food guiding groove 350 in the food releasing impeller casing 340, and a jamming prevention stopper one 360 and a jamming prevention stopper two 370 are provided at an outlet of the food guiding groove 350. In the present embodiment, by weighing the cat food in the food bowl 121 with the load cell 125, it is possible to know weight of the cat food each time eaten by the cat(s), in the meantime, the cat identification device can identify the dining cat(s) and dining time(s) thereof, and by matching the dining cat(s), the dining time(s) and the weight of cat food eaten each time, dining conditions of each cat can be recorded so as to know health status of the cat(s). In the meantime, the silica gel blades 320 and the food releasing blades 330 are used to guide the food, and rotation of the food releasing blades 330 can drive the silica gel blades 320 to rotate, so that when food is jammed in the food releasing blades 330, the silica gel blades 320 as being flexible can provide flexible action forces to unjam the food; a jamming prevention stopper one 360 and a jamming prevention stopper two 370 are provided at the outlet of the food guiding groove 350, a fixing cap 310 is provided on an upper end of a shaft of the silica gel blades 320 and engages with the same, the jamming prevention stopper one 360 and the jamming prevention stopper two 370 are perpendicular to each other in a horizontal direction, one of the jamming prevention stopper one 360 and the jamming prevention stopper two 370 is provided towards to a food outlet 110, so that the cat food will move towards the food outlet 110, and food jamming can be prevented.

The cat identification device comprises one or more electronic tags, and a pedestal 130 fixed on a lower end of the feeder body 100, the food holding mechanism 120 is provided on the pedestal 130, a signal receiver 136 and one or more storage batteries 137 are provided in the pedestal 130, the signal receiver 136 is connected with the one or more storage batteries 137, a controller 131 is provided in the pedestal 130, and the controller 131 is simultaneously connected electrically with the signal receiver 136 and the one or more storage batteries 137, the one or more electronic tags 136 are adapted to the signal receiver 136, and the controller 131 is electrically connected with the load cell 125. The one or more electronic tags are hanging on the cat(s), when the cat(s) come(s) close to the feeder body 100 for dining, the signal receiver 136 can receive radio frequency signals from the one or more electronic tags to identify the cat(s) and know how many times and how long the cat(s) have dined, so as to manage dining of a plurality of cats. In the present embodiment, the signal receiver 136 is an electronic tag reader, and the electronic tag reader can be provided at any position in the feeder body 100.

Stopping mechanisms 200 are provided at both sides of the food holding device 120, an opening 230 is formed by the stopping mechanisms 200 at both sides, the stopping mechanisms 200 are arc-shaped stoppers, installation bulges extending downwardly are provided at bottom portions of the stopping mechanisms 200; a fixing layer 150 is provided at both sides of the feeder body 100, and vertical slots are provided in the fixing layer, engagement of the vertical slots and the installation bulges fixes the stopping mechanisms 200 and the fixing layer 150. By providing the stopping mechanisms 200 at the both sides of the food holding device 120, and with the opening 230 formed by the stopping mechanisms 200, only one cat can eat at one time, so that scrambling for food of more than one cat can be avoided.

The pedestal 130 in the present embodiment comprises a ring-shaped groove 126 and a circular groove 127 that are intercommunicated from top down, the weighing pallet 122 is provided in the ring-shaped groove 126, both the pallet fixing piece 123 and the load cell 125 are provided in the circular groove 127, and the pallet fixing piece 123 is fixed with an installation piece 128 in the circular groove 127.

In the present embodiment, the pedestal 130 is provided with a battery compartment 134, the one or more storage batteries 137 are provided in the battery compartment 134, a fixing block 135 is provided at a side of the battery compartment, the fixing block 135 is connected with a fixing assembly 132 by screws, a fixing slot 133 is provided in the fixing assembly 132, and the controller 131 is fixed in the fixing slot 133.

The signal receiver 136 in the present embodiment is a ring-shaped signal receiving structure. And with the ring-shaped signal receiving structure it is possible to receive radio frequency signals from different directions, which is more accurate and stable for identification of the electronic tags.

The food outlet 110 is provided at a side of the feeder body 100 that is close to the opening 230, a food outlet direction of the food outlet 110 is directly against the food bowl 121.

In the present embodiment, a width of the opening 230 is 10˜20 cm, when the width is smaller than 10 cm, movement of a cat head is not easy, and when bigger than 20 cm, it is possible that there are simultaneously two cats before the food outlet 110. A height of the stopping mechanisms 200 is 20˜30 cm.

In the present embodiment, the installation bulges include an installation bulge one 221, an installation bulge two 222, an installation bulge three 224 and an installation bulge four 225, and at least one of the installation bulge one 221, the installation bulge two 222, the installation bulge three 224 and the installation bulge four 225 is/are provided with a fixing mechanism 233.

In the present embodiment, the battery compartment further comprises a battery cover 138, and the battery cover 138 is provided with one or more battery cover bulges 139 cooperating with the battery compartment 134. A cushioning layer 140 is provided under a lower end of the pedestal 130, a transparent stopper 210 is provided at a side wall of each of the stopping mechanisms 200. One or more stickers 211 are provided on the transparent stopper 210.

The above-mentioned embodiments only show an embodiment of the present invention. The description is more specific and detailed, but it should not be construed as a limitation on the scope of the present invention; it should be pointed out that for those of ordinary skill in the art In other words, without departing from the concept of the present invention, a number of modifications and improvements can be made, which belong to the scope of protection of the present invention; therefore, the scope of protection of the patent for the present invention shall be defined by the appended claims.

1. An intelligent cat feeder, comprising a feeder body (100) and a food holding mechanism (120) provided in the feeder body (100), and the food holding mechanism (120) comprises a food bowl (121) and a weighing pallet (122), wherein the food bowl (121) is provided on the weighing pallet (122), a pallet fixing piece (123) is provided at a bottom portion of the weighing pallet (122), a load cell (125) is provided in the pallet fixing piece (123); the intelligent cat feeder further comprises a cat identification device and a food unjamming device, wherein the food unjamming device is provided in a food cavity in the feeder body (100), and the food unjamming device comprises silica gel blades (320), food releasing blades (330) and a food releasing impeller casing (340) provided in sequence from top down, wherein the silica gel blades (320), the food releasing blades (330) are coaxially provided, and the food releasing blades (330) are provided in a food guiding groove (350) in the food releasing impeller casing (340), and a food jamming prevention stopper one (360) and a food jamming prevention stopper two (370) are provided at an outlet of the food guiding groove (350).

2. The intelligent cat feeder according to claim 1, wherein the cat identification device comprises one or more electronic tags and a pedestal (130) provided at a lower end of the feeder body (100), the food holding mechanism (120) is provided in the pedestal (130), a signal receiver (136) and one or more storage batteries (137) are provided in the pedestal (130), and the signal receiver (136) is connected with the one or more storage batteries (137), a controller (131) is provided in the pedestal (130), and the controller (131) is connected electrically with both the signal receiver (136) and the one or more storage batteries (137); the one or more electronic tags cooperate with the signal receiver (136) and the controller (131) is connected electrically with the load cell (125).

3. The intelligent cat feeder according to claim 1, wherein stopping mechanisms (200) are provided at both sides of the food holding mechanism (120), and the stopping mechanisms (200) at the both sides form an opening (230), wherein the stopping mechanisms (200) are arc-shaped stopping plates, installation bulges extending downwardly are provided at bottom portions of the stopping mechanisms, a fixing layer (150) is provided on both sides of the feeder body (100), and a vertical slot is provided in the fixing layer (150), and the slot engages with the installation bulges to connect the stopping mechanisms (200) with the fixing layer (150).

4. The intelligent cat feeder according to claim 2, wherein a ring-shaped groove (126) and a circular groove (127) are provided in the pedestal (130) from bottom up, wherein the weighing pallet (122) is provided in the ring-shaped groove (126), both the pallet fixing piece (123) and the load cell (125) are provided in the circular groove (127), and the pallet fixing piece (123) is fixedly connected with an installation piece (128) in the circular groove (127).

5. The intelligent cat feeder according to claim 2, wherein a battery compartment (134) is provided in the pedestal (130), the one or more storage batteries (137) are provided in the battery compartment (134), a fixing block (135) is provided at a side of the battery compartment (134), a fixing assembly (132) is connected to the fixing block (135) via screws, a fixing slot (133) is provided in the fixing assembly (132), and the controller (131) is provided in the fixing slot (133).

6. The intelligent cat feeder according to claim 2, wherein a fixing cap (310) adapted to an upper end of a shaft of the silica gel blades (320) is provided thereon, and the food jamming prevention stopper one (360) and the food jamming prevention stopper two (370) are perpendicular to each other in a horizontal direction.

7. The intelligent cat feeder according to claim 2, wherein a food outlet (110) is provided in the feeder body (100) close to the opening (230), and a food outlet direction at the food outlet (110) is against the food bowl (121).

8. The intelligent cat feeder according to claim 3, wherein a width of the opening (230) is 10˜20 cm, and a height of the stopper mechanisms (200) are 20˜30 cm.

9. The intelligent cat feeder according to claim 3, wherein the installation bulges comprises an installation bulge one (221), an installation bulge two (222), an installation bulge three (224) and an installation bulge four (225), wherein both sides of at least one of the installation bulge one (221), the installation bulge two (222), the installation bulge three (224) and the installation bulge four (225) are provided with fixing mechanisms (223).

10. The intelligent cat feeder according to claim 5, wherein the battery compartment (134) comprises a battery cover (138), and the battery cover (138) is provided with battery cover bulges (139) engaging with the battery compartment.
